(19) United States
(12) Patent Application Publication
(10) Pub. No.: US 2014/0106168 A1
(43) Pub. Date: Apr. 17, 2014

(54) X-RAY-OPAQUE BARIUM-FREE GLASS AND USES THEREOF, ESPECIALLY IN POLYMER-BASED DENTAL COMPOSITIONS

(71) Applicants: Simone Monika Ritter, Mainz (DE); Sabine Pichler-Wilhelm, Landshut (DE); Carina Dobler, Landau (DE); Stefanie Hansen, Gensingen (DE)

(72) Inventors: Simone Monika Ritter, Mainz (DE); Sabine Pichler-Wilhelm, Landshut (DE); Carina Dobler, Landau (DE); Stefanie Hansen, Gensingen (DE)

(21) Appl. No.: 13/650,505

(22) Filed: Oct. 12, 2012

(51) Int. Cl. C03C 4/08; C03C 3/095; C03C 3/097; B32B 17/02

(52) U.S. Cl. 428/392; 501/64; 501/63

(57) ABSTRACT

The X-ray-opaque glass, which is free of BaO and PbO except for at most impurities, has a refractive index n_{d} of from 1.50 to 1.58 and a high X-ray opacity with an aluminium equivalent thickness of at least 300%. The glass is based on a SiO₂—Al₂O₃—SrO—R₂O system with additions of La₂O₃ and ZrO₂. The glass has very good chemical resistance and can be used, in particular, as a dental glass or as an optical glass.

### CROSS-REFERENCE

The subject matter described and claimed herein below is also described in German Patent Application No. 10 2011 084 501.1, filed on Oct. 14, 2011 in Germany. This German Patent Application provides the basis for a claim of priority of invention for the invention described and claimed herein below under 35 U.S.C. 119 (a)-(d).

### BACKGROUND OF THE INVENTION

1. The Field of the Invention

The invention relates to a barium-free and lead-free X-ray-opaque glass and uses thereof, especially in polymer-based dental compositions as a filler or an inert particulate material.

2. The Description of the Related Art

In the dental sector, polymer-based dental compositions are increasingly being used for tooth restoration. These polymer-based dental compositions usually consist of a matrix of organic resins and various inorganic fillers. The inorganic fillers consist predominantly of powders of glasses, (glass-)ceramics, silica or other crystalline materials (e.g. YbF₃), sol-gel materials or AEROSIL® and are added as filler material to the polymer-based composition.

The use of polymer-based dental compositions seeks to avoid possible harmful secondary effects of amalgam and also to achieve an improved aesthetic impression. Depending on the choice of the polymer-based dental compositions, they can be used for various tooth restoration measures, for example for tooth fillings and also for fixtures such as crowns, bridges and inlays, onlays, etc.

The filler material as such is intended to minimize the shrinkage caused by polymerization of the resin matrix during curing. If, for example, there is a strong adhesion between tooth wall and filling, excessive polymerization shrinkage can lead to fracture of the tooth wall. If the adhesion is insufficient, excessive polymerization shrinkage can bring about formation of peripheral cracks between tooth wall and filling, which can promote secondary caries. In addition, the fillers have to meet the following particular physical and chemical requirements.

The filler material must be processed to produce very fine powders. The finer the powder, the more homogeneous is the appearance of the filling. At the same time the polishability of the filling is improved, which leads, by reducing the area exposed to attack, to improved abrasion resistance and thus to greater durability of the filling. For the powders to be able to be processed readily, it is also desirable for the powders not to agglomerate. This undesirable effect occurs, in particular, in the case of filler materials which have been produced by means of sol-gel processes.

Furthermore, it is advantageous for the filler to be coated with a functionalized silane since this makes formulation of the dental composition easier and improves the mechanical properties. In this case, it is usually primarily the surfaces of the filler particles which are at least partly coated with the functionalized silane.

In addition, the polymer-based dental composition in its totality and thus also the filler should be matched as well as possible to the natural tooth material in terms of their refractive index and color so that they are ideally virtually indistinguishable from the surrounding healthy tooth material. A very small particle size of the pulverized filler likewise plays a role for this aesthetic criterion.

It is also important that the thermal expansion of the total system composed of polymer-based dental composition and the glass material present therein as filler is matched to that of the natural tooth material in the use range, i.e. usually from −30° C. to +70° C., in order to ensure a sufficient thermal shock resistance of the tooth restoration measure. An excessively large temperature change can also result in cracks being formed between the polymer-based dental compositions and the surrounding tooth material, which can in turn represent preferential points of attack for secondary caries. In general, fillers having a very low coefficient of thermal expansion are used in order to compensate for the large thermal expansion of the resin matrix.

Good chemical resistance of the fillers towards acids, alkalis and water and also good mechanical stability under load, e.g. due to chewing motion, can also contribute to a long life of the tooth restoration measures. The fillers should likewise be resistant to treatment of the teeth with fluoride.

For the treatment of patients, it is also absolutely necessary for tooth restoration measures to be visible in an X-ray image. Since the resin matrix is generally invisible in the X-ray image, the fillers have to provide the necessary X-ray absorption. A filler of this type which absorbs X-radiation sufficiently is referred to as X-ray-opaque. Constituents of the filler, for example particular components of a glass, or additives are generally responsible for the X-ray opacity. Such additives are also referred to as X-ray opacifiers. A widely used X-ray opacifier is YbF₃, which can be added in crystalline, milled form.

The X-ray opacity of dental glasses or materials is reported according to DIN ISO 4049 relative to the X-ray absorption of aluminum as aluminum equivalent thickness (ALET). An ALET of 200% thus means that a glass plate having parallel surfaces and a thickness of 2 mm produces about the same X-ray attenuation as an aluminum plate having a thickness of 4 mm. Analogously, an ALET of 500% means that a glass plate having parallel surfaces and a thickness of 2 mm produces about the same X-ray attenuation as an aluminum plate having a thickness of 10 mm.

Since the polymer-based dental composition is usually introduced into cavities from cartridges and modeled in the cavities, it should frequently be thixotropic in the uncured state. This means that its viscosity decreases on application of pressure, while it is dimensionally stable without the action of pressure.

Among polymer-based dental compositions, a further distinction should be made between dental cements and composites. In the case of dental cements, for example also referred to as glass ionomer cements, the chemical reaction of the fillers with the organic matrix leads to curing of the dental composition, as a result of which the reactivity of the fillers influences the curing properties of the dental composition and thus its processability. A setting process which can be preceded by free-radical surface curing, for example under the action of UV light, is often involved here. The glass can serve as a filler, which triggers the chemical reaction or participates therein, or else as inert particulate material which does not participate in the reaction. The chemical reaction is then brought about by further fillers which are likewise present in the glass ionomer cement.

On the other hand, composites, also known as filling composites, contain further chemically largely inert fillers, since their curing behavior is determined by constituents of the resin matrix itself and thus initially and a chemical reaction of the fillers and/or particulate materials is often undesirable here.

Since glasses represent a glass of materials having a variety of properties because of their different compositions, they are frequently used as fillers for polymer-based dental compositions. Other uses as dental material, either in pure form or as component of a mixture, are likewise possible, for example for inlays, onlays, facing material for crowns and bridges, material for artificial teeth or other material for prosthetic, preserving and/or preventative tooth treatment. Such glasses used as dental material are generally referred to as dental glasses.

Apart from the above-described properties of the dental glass, freedom from barium oxide (BaO) because of possible secondary effects which damage health and from the toxic lead oxide (PbO) is also desirable.

Furthermore, it is likewise desirable for the dental glasses to contain zirconium oxide (ZrO₂) as component ZrO₂ is a widespread material in industrial applications of tooth technology and optics. ZrO₂ is very biocompatible and is insensitive to temperature fluctuations. It is used for many types of tooth care in the form of crowns, bridges, inlays, movement work and implants.

Dental glasses are thus particularly high-quality glasses. Such glasses can likewise be used in optical applications, in particular when the application profits from the X-ray opacity of the glass. Since the X-ray opacity means that the glass absorbs electromagnetic radiation in the region of the X-ray spectrum, such glasses are at the same time filters for X-radiation. Sensitive electronic components can be damaged by X-radiation. In the case of electronic image sensors, passage of an X-ray quantum can, for example, damage the corresponding region of the sensor or lead to an undesirable sensor signal which can be perceived, for example, as interference in the image and/or noise pixels. It is therefore necessary or at least advantageous in particular applications to protect the electronic components from X-radiation by filtering this out from the spectrum of the incident radiation by means of appropriate glasses.

Numerous dental glasses and other optical glasses having a similar optical position or comparable chemical composition have been described in the prior art, but these glasses have considerable disadvantages in production and/or use. In particular, many of the glasses contain relatively large proportions of fluorides and/or Li₂O which vaporize very easily during melting and re-melting, as a result of which precise setting of the glass composition is made difficult.

U.S. Pat. No. 5,976,999 and U.S. Pat. No. 5,827,790 relate to glass-like ceramic compositions in use, inter alia, as dental porcelains. CaO and Li₂O are necessarily present in proportions of at least 0.5% by weight and 0.1% by weight, respectively. Apart from the two main components from the group consisting of ZrO₂, SnO₂ and TiO₂, CaO in an amount of at least 0.5% by weight appears to be indispensible therein. These components result in an increased refractive index n_{d} and only a low X-ray opacity. The glasses of these two documents also necessarily contain at least 10% by weight of B₂O₃. The relatively high proportion of B₂O₃ in combination with the alkali metal contents of at least 5% by weight or at least 10% by weight leads to the chemical resistance of the glass being unacceptably impaired and they are therefore unsuitable for dental glasses.

Chemically inert dental glasses for use as filler in composites are the subject matter of DE 198 49 388 A1. The glasses proposed there necessarily contain appreciable proportions of ZnO and F. The latter can lead to reactions with the resin matrix, which can in turn have effects on the polymerization behavior thereof. In addition, the SiO₂ content is limited to 20-45% by weight, and therefore sufficient X-ray opacifiers and F can be present in the glass described.

WO 2005/060921 A1 describes a glass filler which is, in particular, said to be suitable for dental composites. This contains from 9 to 20 mol % of alkali metal oxides. The objective of this document is to provide glass particles whose alkali metal ion concentration at the periphery of the particles is lower than in the middle thereof. This means that the glasses described cannot be chemically resistant since otherwise this concentration behavior would not be able to be achieved. It can be assumed that the low chemical resistance required is achieved by means of the cited proportions of the alkali metals in the starting glass.

An alkali metal silicate glass which serves as filler for dental material is described in EP 0885606 B1. The Al₂O₃ content of at least 5% by weight increases the viscosity in the glass having a high SiO₂ content and therefore leads to very high melting temperatures. Furthermore, the glasses necessarily contain fluorine. However, fluorides tend to vaporize easily during melting of the glass, which makes precise setting of the glass composition difficult and leads to inhomogeneity. In addition, the proportion of the component CaO, which in this system gives the glass its X-ray opacity, is from 0.5 to 3% by weight and therefore too low to achieve the required X-ray opacity with an ALET of at least 300%.

DE 4443173 A1 concerns high-zirconium glass having a ZrO₂ content of more than 12% by weight and containing other oxides. Such fillers are too reactive, in particular for very modern dental compositions based on epoxy which can cure too quickly and in an uncontrolled manner. Zirconium oxide in this amount tends to lead to devitrification. It brings about phase separation, possibly with nucleation and subsequent crystallization. In addition, such glasses can only be produced with high alkali metal contents in order to ensure a melting temperature which is not too high and would overstress the melting apparatuses. However, such high alkali metal contents lead to a disadvantageously low chemical resistance of the glasses.

DE 199 45 517 A1 likewise describes a high-zirconium glass which in applications in the dental sector leads to the same problems as those associated with the glasses of the previously mentioned document.

JP 2004-002062 A discloses a glass substrate for flat screen displays. The glasses disclosed contain SrO together with predominantly BaO and high proportions of Al₂O₃ and MgO. The components Al₂O₃, SrO, BaO and MgO are required as network transformers in order to ensure fusibility of the glass. These glasses, too, do not come into consideration for use as dental glasses because they can contain BaO or in the low-BaO variants do not have anywhere near the required X-ray opacity. Apart from this, the Al₂O₃ content leads to the viscosity of the high-SiO₂ glass being increased and high melting temperatures therefore being required for production. High contents of MgO are disadvantageous in glasses for dental applications, which should have low refractive indices and at the same time high X-ray opacity. MgO does not increase the X-ray opacity to the same extent as the other alkaline earth metal oxides CaO, SrO and BaO, but makes its presence known mainly in an increase in the refractive index n_{d} and can thus make it difficult to achieve the desired balance between low refractive index and high X-ray opacity.

All the glasses mentioned in the prior art either have little weathering resistance or are too reactive and/or are not X-ray opaque or contain components which damage the environment and/or health.

### SUMMARY OF THE INVENTION

It is an object of the invention to provide a barium- and lead-free X-ray-opaque glass having a relatively low refractive index n_{d} of 1.50 to 1.58. The glass should be suitable as dental glass and as optical glass. It should be inexpensive to produce and nevertheless be of high quality and compatible to the human body and also be suitable for passive and active tooth protection and have advantageous properties regarding processability, bonding behavior of surrounding polymer matrices and also long-term stability and strength. To meet the requirements in modern tooth treatment and dental technology, the glass according to the invention also should have excellent chemical resistance.

Furthermore, the base matrix of the glass of the invention should, apart from at the most impurities, be free of color-imparting components such as Fe₂O₃, CoO, NiO, CuO etc., in order to allow an optimal color starting point for possible matching to the tooth color and/or in the case of optical applications the transmission spectrum of the electromagnetic radiation. In addition, it should be free of a second glass phase and/or color-imparting particles, which lead to scattering and likewise alter the color impression. One or more further glass phases would reduce the stability of the glasses.

The object is achieved by the glass according to the independent claim or claims. Preferred embodiments and uses can be derived from the dependent claims.

The glass of the invention has a refractive index n_{d} of 1.50 to 1.58. It is therefore matched very well to the available dental polymers and/or epoxy resins in this refractive index range, as a result of which it satisfies the aesthetic requirements in terms of a natural appearance required of a dental glass-polymer composite very well.

The glass of the invention achieves the properties of barium-containing and/or lead-containing dental glasses regarding X-ray absorption without use of barium and lead and advantageously other substances, which are problematical in terms of health. Here, the expression “free of” means absence of these substances except for at most unavoidable contamination which can, for example, be caused by air pollution and/or as impurities in raw materials used. However, even contamination of the glass with the undesirable impurities must generally not exceed 100 ppm, preferably not more than 50 ppm in the case of Fe₂O₃, 30 ppm in the case of PbO, 5 ppm in the case of As₂O₃, 20 ppm in the case of Sb₂O₃ and 100 ppm for others. BaO is always closely associated with the SrO in the raw material. Depending on the purity of the SrO raw material, up to 0.37% by weight BaO can be present in the glass of the invention. These limits are encompassed by the formulation “free of . . . except for at most impurities”. Naturally, complete absence of the above-mentioned undesirable substances in the glass of the invention is particularly preferred.

The X-ray absorption and thus the X-ray opacity is, according to the invention, achieved mainly by means of the content of SrO and the further components Cs₂O and/or La₂O₃ and/or SnO₂ and/or ZrO₂, which are present in a combined amount of 10% by weight or more in the glass of the invention. In contrast to earlier dental glasses which attempted to achieve the X-ray opacity by means of the high content of an ideally highly absorbing component, the X-ray opacity according to the invention is preferably achieved by the suitable combination of these components which are effective for X-ray opacity. In this way, the particularly strict demands made of the optical properties of the glass and also the very good chemical resistance can be achieved. A total content of SrO and the further components Cs₂O and/or La₂O₃ and/or SnO₂ and/or ZrO₂ is preferably at least 11% by weight, in particular 12% by weight, particularly preferably at least 15% by weight.

SrO is always present in the glass of the invention. Its content is from 4 to 17% by weight. Preference is given to the range from 4 to 16% by weight, particularly preferably from 5 to 15% by weight, very particularly preferably from 6 to 14% by weight. In combination with other X-ray opacifiers, SrO ensures, according to the invention, the good X-ray opacity of the glass. Although the X-ray absorption spectrum of SrO in glasses in the range of conventional tungsten X-ray tubes in the region of an operating voltage of 65 keV is suboptimal, it has surprisingly been found that very good X-ray opacities can be achieved by the combination with the other substances described herein.

The glass of the invention has, inter alia, as a result of the aforesaid measures, an aluminum equivalent thickness (ALET) of at least 300%, preferably at least 350%, particularly preferably at least 390%. This means that a glass plate composed of the glass of the invention and having parallel surfaces and a thickness of 2 mm brings about at least the same X-ray attenuation as an aluminum plate having a thickness of 6 mm.

As base component, the glass of the invention contains SiO₂ in a proportion of from 55 to 75% by weight as glass-forming component. Higher contents of SiO₂ can lead to disadvantageously high melting temperatures, while, in addition, the required X-ray opacity cannot be achieved. Lower contents can have an adverse effect on the chemical resistance. A preferred embodiment of the glass of the invention provides for a content of from 56 to 74% by weight and particularly preferably from >59 to 70% by weight of SiO₂. B₂O₃ is only optionally provided for in the glass of the invention. It can be present in the range from 0 to 9% by weight. B₂O₃ serves as flux. Apart from the effect of lowering the melting temperature, the use of B₂O₃ simultaneously leads to an improvement in the crystallization stability of the glass of the invention. Proportions of more than about 9% by weight are not recommended in this system in order not to put the very good chemical resistance at risk. B₂O₃ is preferably used in a proportion of from 0 to 7% by weight and particularly preferably from 0 to 4% by weight. If B₂O₃ is present in the glass of the invention, preference is given to likewise introducing a small proportion of more than 0.5% by weight of alkali metal oxides into the glass in order to avoid undesirable scattering at demixed regions analogous to the Tyndall effect.

In the glass of the invention, Al₂O₃ is necessarily present in the range from 0.5 to 4% by weight. Al₂O₃ makes, inter alia, good chemical resistance possible. However, an Al₂O₃ content of about 4% by weight should not be exceeded, so as not to increase the viscosity of the glass, especially in the hot processing region, to such an extent that the glass is difficult to melt. The upper limit to the Al₂O₃ content is preferably 3.5% by weight, particularly preferably even only 3% by weight, very particularly preferably even only 2% by weight.

Alkali metal oxides can reduce the chemical resistance of a glass, but on the other hand can be necessary to enable the glass to be melted at all. According to the invention, the total content of the alkali metal oxides Li₂O and/or Na₂O and/or K₂O is from 0.5 to 12% by weight, preferably from 0.5 to 11% by weight, particularly preferably from 2 to 10% by weight, very particularly preferably from 3 to 9% by weight. The invention provides for a balance of these alkali metals in the specified ranges. In particular, alkali metal oxides from the group consisting of Li₂O and/or Na₂O and/or K₂O can, in the glasses of the invention, counter demixing of the glass matrix and thus undesirable scattering analogous to the Tyndall effect. A total amount of at least 0.5% by weight of the alkali metal oxides is therefore present. In addition, the alkali metal oxides together with B₂O₃ aid melting of the glass at acceptable temperatures. However, the maximum of 12% by weight of the alkali metal oxides mentioned should not be exceeded in order to be able to achieve the very high resistance of the glass of the invention.

Specifically, the content of these alkali metal oxides is, according to the invention, from 0 to 2% by weight of Li₂O, preferably from 0 to 1% by weight, particularly preferably from 0 to <1% by weight. The very low proportions of Li₂O help to achieve the very good chemical resistance. For this reason, a very particularly preferred glass is also free of Li₂O except for at most impurities.

The content of Na₂O can be higher than that of Li₂O. According to the invention, Na₂O is present in an amount of from 0 to 7% by weight, preferably from 0 to 5% by weight and particularly preferably from 0 to 4% by weight and very particularly preferably from 0 to 3% by weight.

K₂O can be present in an amount of from 0 to 9% by weight in the glass of the invention. Preference is given to the range from 0 to 8% by weight, particularly preferably from 0 to 7% by weight and very particularly preferably from 0 to 6% by weight. Li₂O, Na₂O and K₂O can in particular contribute to better melting of a SiO₂- and ZrO₂-containing glass.

Cs₂O likewise contributes to improving the fusibility, but according to the invention at the same time serves to increase the X-ray opacity and to set the refractive index in synergy with the other components. According to the invention, Cs₂O is present in an amount of from 0 to 15% by weight, preferably from 1 to 14% by weight and particularly preferably from 2 to 13% by weight and very particularly preferably from 3 to 12% by weight, in a glass according to the invention. The alkali metal Cs is less mobile in a glass matrix compared to the alkali metals Li, Na, K and Rb. It is therefore leached out to a lesser extent and therefore leads to a lesser deterioration in the chemical resistance than the above-mentioned alkali metals.

The glass of the invention can contain a limited proportion of alkaline earth metals from the group consisting of CaO and MgO. The proportion of CaO is from 0 to 11% by weight, preferably from 0 to 10% by weight and particularly preferably from 0 to 8% by weight and more preferably from 0 to 7% by weight. MgO is likewise optional and can be present in an amount of from 0 to <3% by weight, preferably from 0 to <2% by weight and particularly preferably from 0 to <1% by weight. A very particularly preferred embodiment provides for the glass of the invention to be free of MgO except for at most impurities. As indicated above, MgO can be disadvantageous in glasses for dental applications which are intended to have low refractive indices and at the same time a high X-ray opacity. MgO does not increase the X-ray opacity to the same extent as the other alkaline earth metal oxides CaO, SrO and BaO because the X-ray absorption edge of MgO is far below those of the other three and exercises only a small influence in the region of the tungsten X-ray tubes used in the medical sector. MgO would merely increase the refractive index and thus make it harder to achieve the balance between a low refractive index and high X-ray opacity.

Furthermore, the glass of the invention necessarily contains ZrO₂ in a proportion of from >1 to <11% by weight. This zirconium content improves the mechanical properties, in particular the tensile strength and compressive strength, and also reduces the brittleness of the glass. In addition, the component makes a similar contribution to the X-ray opacity as the proportion of SrO in the glass. However, contents which are too high can lead to the glass being reactive, in particular in the environment of dental polymers. The glass should, on the other hand, be at least largely inert towards dental polymers, in particular composites, and, for example, not interfere in the polymerization behavior thereof. Preference is given to a ZrO₂ content of from 1 to less than 10% by weight, particularly preferably from 2 to 9.5% by weight, very particularly preferably from 2 to 9% by weight.

Since ZrO₂ is sparingly soluble in silicate glasses and demixing can therefore easily occur, the above-mentioned proportion of ZrO₂ should not be exceeded. Demixed regions which can be formed in the case of excessively high ZrO₂ contents, in particular in combination with likewise high proportions of SiO₂, act as scattering centers for light passing through in a manner analogous to the Tyndall effect. In the case of dental glasses, these scattering centers can spoil the aesthetic impression, which is why demixed glasses are generally undesirable in dental applications, and in an optical glass the scattering centers generally have a negative effect on the transmission and demixed glasses are therefore likewise undesirable in most optical applications. In addition, demixed glasses can, owing to the phases of various compositions and thus different leaching properties, lead to a reduction in the resistance.

La₂O₃ is present in the glass of the invention in an amount of from 1 to 10% by weight. As indicated, it ensures, optionally with SrO and ZrO₂ and optionally Cs₂O and/or optionally SnO₂, the X-ray opacity of the glass. The La₂O₃ content is preferably from 2 to 8% by weight, particularly preferably from 3 to 7% by weight and very particularly preferably from 3 to 6% by weight.

Like Cs₂O, SnO₂ can be present in the glass of the invention as optional component in order to achieve a high X-ray opacity with an ALET of at least 300%. In addition, this component has the advantage that it does not increase the refractive index to the same extent as La₂O₃ and/or Ta₂O₅. SnO₂ therefore also helps to set the low refractive index of from 1.5 to 1.58 combined with a high X-ray opacity. It can therefore be present in an amount of from 0 to 4% by weight in the glass. It is preferably present in an amount of from 0 to 3% by weight in a glass according to the invention.

The glass of the invention is optionally free of CeO₂ and TiO₂, except for not more than impurities. Owing to their absorption in the UV range, CeO₂ and TiO₂ shift the UV edge of the glass, so that an undesirable yellowish coloration can be obtained.

In order to achieve a high X-ray opacity and correspondingly particularly high values for the aluminum equivalent thickness, preferred embodiments of the glass of the invention provide for SrO and Cs₂O and La₂O₃ and ZrO₂ and/or SnO₂ to be present in a total amount of more than 18% by weight, preferably more than 20% by weight, particularly preferably more than 21% by weight, very particularly preferably more than 22% by weight, in the glass.

To ensure that the glass does not decompose, it can be preferred that the numerical value of the ratio of the content of SiO₂ to ZrO₂ is at least 6.5, particularly preferably more than 7.

WO₃ and/or Nb₂O₅ and/or HfO₂ and/or Sc₂O₃ and/or Y₂O₃ and/or Yb₂O₃ can preferably and optionally be additionally present either individually or in any combinations in an amount in each case of from 0 to 3% by weight, and Ta₂O₅ can optionally be present in any combination in an amount of from 0 to 5% by weight.

The invention also provides for the glass of the invention to be free of B₂O₃ (except for at most unavoidable impurities).

As indicated, the glass of the invention is free of the undesirable components BaO and PbO (except for at most the impurities described). The addition of other substances which damage the environment and/or health is preferably dispensed with.

To ensure particularly good melting properties of the glass, the invention likewise provides that the sum of the contents of MgO and/or CaO and/or SrO is less than 17% by weight. If the glass is difficult to melt, undue stress is placed on the melting apparatuses and the glass can only be melted with increased difficulty, generally making production no longer economical.

The glass transformation temperature T_{g} of a glass according to the invention is preferably at least 570° C. The glass thus has a high heat resistance, which makes it suitable for other fields of application, in particular fields of application described below.

The coefficient of linear thermal expansion α₍₂₀₋₃₀₀₎ measured in the temperature range from 20° C. to 300° C. of the glass of the invention is preferably less than 7·10⁻⁶ K⁻¹. The low coefficient of thermal expansion enables the glasses of the invention, especially when used as filler material in polymers, to compensate for the naturally high thermal expansion of the polymers, so that the polymer-containing data composition has a resulting thermal expansion which is better matched to the natural tooth material.

As stated above, the glasses of the invention are particularly resistant to chemical attacks, i.e. they are particularly chemically resistant. They preferably have an acid resistance S in accordance with DIN 12116 of class 2 or better, an alkali resistance L in accordance with DIN ISO 695 of class 1 and a water resistance HGB in accordance with DIN ISO 719 of class 2 or better. The tests for the alkali resistance L and acid resistance S are very much more demanding than the test standards DIN ISO 10629 and ISO 8424 used hitherto, so that the glasses of the invention have, in particular, an improved alkali and acid resistance.

The invention likewise provides for the glasses of the invention to have very good resistance to attack by NaF. The test method is explained in more detail below in this text in relation to the examples. This test aims to test the resistance of the glasses to fluorine and/or fluorides. These materials can strongly attack glass, but are often used in tooth cleaning materials and/or for fluoridation and/or strengthening of healthy tooth material by, inter alia, the dentist.

The glasses of the invention are thus all characterized by a very good chemical resistance, which leads to a high inertness in respect of reaction with the resin matrix and thus leads to a very long life of the total dental composition.

In a further preferred embodiment of the present invention, the glass the invention is preferably also free of other components not mentioned in the claims and/or this description. This means that, in such an embodiment, the glass consists essentially of the specified components. The expression “consist essentially of” means that other components are present at most as impurities, but are not deliberately added as individual components to the glass composition.

However, the invention also provides for the glass of the invention to be used as a basis for further glasses in which up to 5% by weight of further components can be added to the inventive glass described. In such a case, the glass consists, according to the invention, of the glass described to an extent of at least 95% by weight.

It is of course also possible to modify the color appearance of the glass by addition of oxides customary for this purpose. Oxides suitable for coloring glasses are known to those skilled in the art; mention may be made by way of example of CuO and CoO which for these purposes can preferably be added in an amount of from 0 to 0.5% by weight. In addition, the glass can be given an antiseptic function by additions of, for example, Ag₂O in an amount of from 0 to 3% by weight.

The invention additionally encompasses glass powders composed of the glasses of the invention. The glass powders are produced by known methods, as described, for example, in DE 41 00 604 C1. The glass powder according to the invention preferably has an average particle size of up to 50 μm, particularly preferably up to 20 μm. An average particle size of 0.1 μm can be achieved as lower limit, and smaller particle sizes are naturally also encompassed by the invention. The above-mentioned glass powder can generally serve as starting material for use of the glasses of the invention as fillers and/or dental glasses.

In a preferred embodiment, the surface of the glass powder is silanized by customary methods. The silanization can improve the bonding of the inorganic fillers to the polymer matrix of the polymer-based dental composition.

The glass of the invention can, as described, preferably be used as dental glass. It is preferably employed as a filler in composites for tooth restoration, particularly preferably for filling materials based on epoxy resin, which require largely chemically inert fillers. The invention likewise provides for the use of the glass of the invention as X-ray opacifier in dental compositions, in particular polymer-based dental compositions. The glass of the invention is suitable for replacing expensive crystalline X-ray opacifiers such as YbF₃. The glass of the invention is likewise suitable for and provided for use as filler in glass ionomer cements. It is likewise possible to use the glass of the invention as inert particulate material in glass ionomer cements. Particular preference is given to the use as inert particulate material in polymer-reinforced glass ionomer cements. Polymer-reinforced glass ionomer cements are a class of materials which have been available for only a few years and which themselves display the curing reaction of a cement, which can take a very long time, but also contain a resin matrix like the above-described composites in order to be initially curable.

Accordingly, the glass of the invention is preferably used for producing a dental glass-polymer composite containing a dental polymer, where the dental polymer is preferably a UV-curable resin based on acrylate, methacrylate, 2,2-bis-[4-(3-methacryloyloxy-2-hydroxypropoxy)-phenyl]-propane (bis-GMA), triethylenglycol-methacrylate (TEGDMA), urethane methacrylate (UDMA), alkanediol dimethacrylate- or cyanoacrylate.

The invention likewise encompasses the use of the glass of the invention as optical element containing the glass of the invention. For the purpose of the present invention, optical elements are all objects and in particular components which can be used for optical applications. These can be components through which light passes. Examples of such components are cover glasses and/or lens elements but also supports for other components such as mirrors and glass fibers.

Cover glasses are preferably used for protecting electronic components. These obviously likewise encompass optoelectronic components. The cover glasses are usually in the form of glass plates having flat parallel surfaces and are preferably installed above the electronic component so that the latter is protected from environmental influences but electromagnetic radiation such as light can pass through the cover glass and interact with the electronic component. Examples of such cover glasses are the inside of optical caps, for the protection of electronic image sensors, covering wafers in wafer level packaging, cover glasses of photovoltaic cells and protected glasses for organic electronics. Further applications of cover glasses are adequately known to those skilled in the art. It is likewise possible for optical functions to be integrated into the cover glass, for example when it is provided at least in regions with optical structures which can preferably have the form of lenses. Cover glasses provided with micro lenses are usually employed as cover glasses of image sensors for digital cameras, where the micro lenses usually focus light impinging obliquely on the image sensor onto the individual sensor elements (pixels). It is of course also possible to use the glass of the invention as substrate glass of electronic components, in which case the electronic components are embedded into the substrate glass and/or are applied thereto.

Owing to its optical properties, the glass of the invention can likewise be used for optical applications. Since it is largely chemically inert, it is suitable for uses as substrate glass and/or cover glass in photo-voltaics, for example for covering photovoltaic cells based on silicon, organic photovoltaic cells and/or as support material for thin-film photovoltaic modules. The X-ray absorption of the glass of the invention has, inter alia, particular advantages in the use of photovoltaic modules in spaceflight applications, since these can be subjected to particularly intensive X-radiation outside the earth's atmosphere. In addition, the property of high X-ray absorption allows use quite generally as X-ray protection glass.

The glass of the invention has also found an excellent field of application as cover glass and/or substrate glass of OLEDs because of its properties. For example, due to its chemical resistance also unwanted interactions between the glass and the OLED substances can be avoided or at least suppressed.

The glass of the invention is also suitable for use as cover glass and/or substrate glass for biochemical applications, in particular for molecular screening methods.

Owing to its high heat resistance, the glass of the invention is also suitable as lamp glass, in particular for use in halogen lamps and/or fluorescent tubes and related constructions. If X-radiation is generated by the mechanisms of light generation in the lamp, it is a particular advantage of the glass of the invention that it can keep this away from the surroundings.

In addition, the invention encompasses vaporization of the glass of the invention by means of physical processes and depositing the vaporized glass on components. Such physical vapor deposition processes (PVD processes for short) are known to those skilled in the art and are described, for example, in DF 102 22 964 B4. In such processes, the glass of the invention serves as target to be vaporized. The components onto which the glass of the invention has been vapor-deposited can profit both from the chemical resistance of the glass and from its X-ray absorption.

It is likewise possible to use the glass of the invention as starting material for glass fibers. Here, the term glass fibers encompasses all types of glass fibers, in particular fibers which consist only of a core and core-sheath fibers which have a core and at least one sheath which preferably completely surrounds the core along the outer circumferential surface. The glass of the invention can in this case be used as core glass and/or as sheathing glass. Within the composition range of the glass of the invention, the refractive index n_{d} of the glass can be set so that a core glass according to the invention has a higher refractive index than a sheathing glass according to the invention, so that a step index fiber in which light conduction occurs very efficiently as a result of total reflection at the interface of core and sheath is obtained. The term likewise encompasses side-emitting fibers as described, for example, in WO 2009/100834 A1.

In addition, the glasses of the invention are likewise suitable as matrix material for the secure temporary and/or permanent storage of radioactive waste and also for the embedding of radioactive materials because of their high stability and also, if desired, due to their X-ray absorbance.

This glass also displays advantages in use as container glass or for packaging of pharmaceutical products. Owing to the high resistance to surrounding media, interactions with contents can be virtually ruled out. Owing to its good chemical resistance, another field of application is, in use of the glass fibers according to the invention as reinforcement in composites and/or as concrete reinforcement and/or as optical waveguide fibers embedded in concrete.

### EXAMPLES

Table I contains examples of glasses in the preferred composition range. All amounts in the reported compositions are in percent by weight.

All values of the ALET were determined by a method based on DIN ISO 4049 but using a digital X-ray instrument. The grey values obtained thereby were further processed by means of image analysis software and the X-ray absorption was determined therefrom.

The glasses described in the examples were produced as follows:

The raw materials for the oxides are weighed out without refining agents and subsequently mixed well. The glass mix is melted at about 1580° C. in a discontinuous melting apparatus, then refined and homogenized. At a casting temperature of about 1600° C., the glass can be cast and processed as ribbons or other desired dimensions. In a large-volume, continuous apparatus, the temperatures can be reduced by at least about 100 K.

further processing, the cooled glass ribbons were milled to a glass powder having an average particle size of not more than 10 μm by means of the process known from DE 41 00 604 C1. The glass properties were determined on glass gobs which had not been milled to powders. All glasses display excellent chemical resistance to acids, alkalis, water and fluorine-containing substances such as NaF and NaF/acetic acid.

Table I also reports the refractive indices n_{d}, the glass transition temperature T_{g} and the coefficients of linear thermal expansion α₍₂₀₋₃₀₀₎ from 20 to 300° C. and α₍₋₃₀₋₇₀₎ from −30 to 70° C. The latter is of particular interest for the use of the glass of the invention as dental glass, because the temperature range from −30 to 70° C. can occur in use.

Also the chemical resistance of the variants of the glass of the invention, which is quantified by the values achieved for the acid, alkali and water resistance, is reported in the Table. Here, S denotes the acid resistance class in accordance with DIN 12116, L denotes the alkali resistance class in accordance with DIN ISO 695 and HGB denotes the water resistance class in accordance with DIN ISO 719.

To quantify the excellent chemical resistance of the glasses of the invention further, an even stricter test which tests, in particular, the resistance to fluorine and/or fluorides was carried out. The resistance to fluorine-containing components, which often occur in tooth cleaning materials and serve to fluoridate and/or strengthen healthy tooth material, was tested as follows by means of an NaF solution and an NaF/acetic acid solution: production of a composite from 50% of monomer and 50% of silanized glass powder having an average particle size (d50) of 3 μm measured by laser light scattering (CILAS 1064L instrument). The test specimens are polished on both sides and are exposed to a 0.001 molar NaF solution and a 0.001 molar NaF solution and 4% acetic acid at temperatures of 37° C. and 100° C. for sixteen hours. The surface of the polished specimens is examined by means of SEM before and after the resistance test.

Very good specimens displayed no changes. Good specimens displayed only slight interfacial cracks between the monomer and the glass powder particles. In poor specimens the glass particles were leached out from the monomer matrix. Owing to the outlay for carrying out this test, the results of this test are not yet available for all variants of the glass according to the invention.

All glasses shown in Table I have coefficients of thermal expansion α₍₂₀₋₃₀₀₎ in the range from 20 to 300° C. of less than 7·10⁻⁶ K⁻¹ and are free of BaO within the limits of measurement accuracy of the analysis.

Compared to BaO-containing glasses, glasses shown in Table I have an X-ray opacity which is at least as good. In the examples presented, values of the ALET of from 399% to 763% are achieved.

The examples also demonstrate that the refractive indices n_{d} of the glass system of the invention can be matched to the application, in particular in the range from 1.53 to 1.56, without the required ALET suffering. As a result, it can advantageously be used as, in particular, fillers in dental compositions, but also for other applications which have demanding requirements regarding, inter alia, the purity and the chemical and heat resistance. It can be produced industrially with adequate efforts.

Compared to the prior art, the glass of the invention has the additional advantage that it combines adaptability of the refractive indices and coefficients of expansion and also a constantly very good chemical stability with efficient X-ray absorption.

The glass of the invention is also comparatively easy to melt and therefore efficient to produce.

TABLE I
Compositions and Properties of the X-ray-opaque Glass, in % by weight

| Example No. | 1 | 2 | 3 | 4 | 5 | 6 | 7 |
|---|---|---|---|---|---|---|---|
| SiO₂ | 67.89 | 66.35 | 65.85 | 68.79 | 69.35 | 68.64 | 68.57 |
| B₂O₃ | | | | | | | |
| Al₂O₃ | 0.97 | 0.95 | 0.95 | 1.73 | 1.72 | 1.69 | 1.67 |
| Li₂O | | | | | | | |
| Na₂O | 2.73 | 2.68 | 2.66 | 2.74 | 2.73 | 2.68 | 2.66 |
| K₂O | 1.48 | 0.77 | 1.44 | 2.18 | 2.17 | 1.45 | 1.1 |
| Cs₂O | | | | | | 4.07 | 6.04 |
| CaO | 6.84 | 5.09 | 3.45 | 6.03 | 5.18 | 5.10 | 4.65 |
| MgO | | | | | | | |
| SrO | 7.40 | 10.24 | 13.12 | 7.42 | 7.39 | 7.27 | 7.19 |
| La₂O₃ | 4.79 | 4.69 | 4.66 | 4.8 | 4.78 | 4.70 | 4.65 |
| ZrO₂ | 8.09 | 7.05 | 7.87 | 6.3 | 4.47 | 4.39 | 3.47 |
| SnO₂ | | 2.17 | | | 2.21 | | |
| n_{d} | 1.54958 | 1.55291 | 1.55209 | 1.54131 | 1.53717 | 1.5339 | 1.53043 |
| α₍₂₀₋₃₀₀₎ [10⁻⁶ K⁻¹] | 5.36 | 5.31 | 5.52 | 5.52 | 5.41 | 5.54 | 5.54 |
| α₍₋₃₀₋₇₀₎ [10⁻⁶ K⁻¹] | 4.78 | | | | | | 5.06 |
| T_{g} [° C.] | 722 | 734 | 716 | 708 | 701 | 679 | 672 |
| S [Class] | 1 | | | | | | 1 |
| L [Class] | 1 | | | | | | 1 |
| HGB [Class] | 1 | | | | | | 1 |
| ALET [%] | 427 | 502 | 498 | 399 | 424 | 469 | 503 |
| Resistance to | Very | | | | | | Very |
| NaF/acetic acid | good | | | | | | good |
| Example No. | 8 | 9 | 10 | 11 | 12 | 13 | 14 |
| SiO₂ | 63.46 | 67.3 | 59.66 | 61.14 | 59.70 | 59.91 | 63.02 |
| B₂O₃ | | | | | | | |
| Al₂O₃ | 0.91 | 1.64 | 0.86 | 0.88 | 0.88 | 0.89 | 1.58 |
| Li₂O | | | | | | 0.40 | |
| Na₂O | 2.56 | 2.61 | 2.41 | 2.47 | 2.47 | 2.48 | 2.50 |
| K₂O | 2.67 | 1.74 | 2.88 | 4.20 | 3.84 | 3.85 | 4.21 |
| Cs₂O | 3.88 | 7.9 | 10.95 | 7.48 | 7.50 | 7.53 | 11.38 |
| CaO | 1.78 | 3.77 | | | 1.72 | 0.97 | 2.87 |
| MgO | | | | | | | |
| SrO | 12.65 | 7.06 | 11.89 | 12.19 | 12.22 | 12.26 | 6.78 |
| La₂O₃ | 4.49 | 4.57 | 4.22 | 4.33 | 4.34 | 4.35 | 4.39 |
| ZrO₂ | 7.59 | 3.41 | 7.13 | 7.31 | 7.33 | 7.36 | 3.27 |
| SnO₂ | | | | | | | |
| n_{d} | 1.55138 | 1.53004 | 1.54807 | 1.55489 | 1.54997 | 1.53781 | 1.53321 |
| α₍₂₀₋₃₀₀₎ [10⁻⁶ K⁻¹] | 6.04 | 5.86 | 6.48 | 6.58 | 6.72 | 6.81 | 6.94 |
| α₍₋₃₀₋₇₀₎ [10⁻⁶ K⁻¹] | 5.32 | 5.13 | 5.83 | 5.95 | 6.02 | 6.07 | 6.28 |
| T_{g} [° C.] | 700 | 670 | 681 | 680 | 678 | 636 | 635 |
| S [Class] | 2 | 1 | | | 1 | | 1 |
| L [Class] | 1 | 1 | | | 1 | | 1 |
| HGB [Class] | 1 | 2 | | | 1 | | 2 |
| ALET [%] | 593 | 546 | 763 | 679 | 683 | 684 | 626 |
| Resistance to | Very | Very | | | Very | | Very |
| NaF/acetic acid | good | good | | | good | | good |

| Example No. | 15 | 16 | 17 | 18 | 19 |
|---|---|---|---|---|---|
| SiO₂ | 61.37 | 63.28 | 64.00 | 62.20 | 68.57 |
| B₂O₃ | | 2.97 | 2.98 | | |
| Al₂O₃ | 1.58 | 1.58 | 2.28 | 0.91 | 1.67 |
| Li₂O | 0.40 | | | | |
| Na₂O | 2.5 | 1.26 | 1.26 | 2.55 | 2.66 |
| K₂O | 5.48 | 2.11 | 2.12 | 3.11 | 1.1 |
| Cs₂O | 11.37 | 11.43 | 10.69 | 5.15 | 6.04 |
| CaO | 2.87 | 2.88 | 2.13 | 3.31 | 4.65 |
| MgO | | | | | |
| SrO | 6.78 | 6.81 | 6.83 | 10.72 | 7.19 |
| La₂O₃ | 4.38 | 4.40 | 4.42 | 4.48 | 4.65 |
| ZrO₂ | 3.27 | 3.28 | 3.29 | 7.57 | 3.47 |
| SnO₂ | | | | | |
| n_{d} | 1.55480 | 1.53199 | 1.52969 | 1.55364 | 1.52997 |
| α₍₂₀₋₃₀₀₎ [10⁻⁶ K⁻¹] | 7.64 | 5.63 | 5.54 | | 5.56 |
| α₍₋₃₀₋₇₀₎ [10⁻⁶ K⁻¹] | 6.82 | | 5.06 | | 4.97 |
| T_{g} [° C.] | 586 | 667 | 666 | | 679 |
| S [Class] | | | 1 | | |
| L [Class] | | | 1 | | |
| HGB [Class] | | 1 | 1 | 1 | 1 |
| ALET [%] | 628 | 638 | 617 | 626 | 503 |
| Resistance to | | Very | Very | Very | Very |
| NaF/acetic acid | | good | good | good | good |

While the invention has been illustrated and described as embodied in an X-ray opaque barium-free glass and uses thereof, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. An X-ray-opaque glass having a refractive index n_{d} of 1.50 to 1.58 and an aluminium equivalent thickness of at least 300%, which is free of BaO and PbO except for at most impurities, said glass comprising, in % by weight based on oxide content:

| | |
|---|---|
| SiO₂ | 55-75 |
| B₂O₃ | 0-9 |
| Al₂O₃ | 0.5-4 |
| Li₂O | 0-2 |
| Na₂O | 0-7 |
| K₂O | 0-9 |
| Cs₂O | 0-15 |
| SrO | 4-17 |
| CaO | 0-11 |
| MgO | 0-<3 |
| ZrO₂ | 1-<11 |
| La₂O₃ | 1-10 |
| SnO₂ | 0-4 |
| Li₂O + Na₂O + K₂O | 0.5-12 |
| SrO + Cs₂O + La₂O₃ + SnO₂ + ZrO₂ | ≧10. |

2. The X-ray-opaque glass according to claim 1, said glass comprising, in % by weight based on oxide content:

| | |
|---|---|
| SiO₂ | 56-74 |
| B₂O₃ | 0-7 |
| Al₂O₃ | 0.5-3.5 |
| Li₂O | 0-1 |
| Na₂O | 0-5 |
| K₂O | 0-8 |
| Cs₂O | 1-14 |
| SrO | 4-16 |
| CaO | 0-10 |
| MgO | 0-<2 |
| ZrO₂ | 1-<10 |
| La₂O₃ | 2-8 |
| SnO₂ | 0-3 |
| Li₂O + Na₂O + K₂O | 0.5-11 |
| SrO + Cs₂O + La₂O₃ + SnO₂ + ZrO₂ | ≧11. |

3. The X-ray-opaque glass according to claim 1, said glass comprising, in % by weight based on oxide content:

| | |
|---|---|
| SiO₂ | >59-70 |
| B₂O₃ | 0-4 |
| Al₂O₃ | 0.5-2 |
| Li₂O | 0-<1 |
| Na₂O | 0-3 |
| K₂O | 0-6 |
| Cs₂O | 3-12 |
| SrO | 6-14 |
| CaO | 0-8 |
| MgO | 0-<1 |
| ZrO₂ | 2-9 |
| La₂O₃ | 3-6 |
| SnO₂ | 0-3 |
| Li₂O + Na₂O + K₂O | 3-9 |
| SrO + Cs₂O + La₂O₃ + SnO₂ + ZrO₂ | ≧15. |

4. The X-ray-opaque glass according to claim 1, wherein a sum total amount of SrO and Cs₂O and LaO₃ and SnO₂ and ZrO₂, in % by weight based on oxide content, is >18%.

5. The X-ray-opaque glass according to claim 1, wherein a ratio of respective amounts of SiO₂ and ZrO₂ is such that SiO₂/ZrO₂≧6.5.

6. The X-ray-opaque glass according to claim 1, further comprising, in % by weight based on oxide content:

| | |
|---|---|
| WO₃ | 0-3 |
| Nb₂O₅ | 0-3 |
| HfO₂ | 0-3 |
| Ta₂O₅ | 0-5 |
| Sc₂O₃ | 0-3 |
| Y₂O₃ | 0-3 |
| Yb₂O₃ | 0-3. |

7. The X-ray-opaque glass according to claim 1, which is free of B₂O₃ and/or Li₂O and/or fluorides except for at most impurities and contains <5%, in % by weight based on oxide content, of ZnO.

8. The X-ray-opaque glass according to claim 1, having a coefficient of thermal expansion α₍₂₀₋₃₀₀₎ of less than 7·10⁻⁶ K⁻¹.

9. The X-ray-opaque glass according to claim 1, having an acid resistance S of class 2 or better in accordance with DIN 12116, an alkali resistance L of class 1 in accordance with DIN ISO 10695 and a water resistance HGB of class 2 or better in accordance with DIN ISO 719.

10. A glass comprising at least 95% by weight of said X-ray-opaque glass according to claim 1.

11. A glass powder comprising said X-ray-opaque glass according to claim 1.

12. A filler for dental composites used for tooth restoration, said filler consisting of said X-ray-opaque glass according to claim 1.

13. A filler used in glass ionomer cements, wherein said filler is an inert particulate material consisting of said X-ray-opaque glass according to claim 1.

14. An X-ray opacifier in polymer-based dental compositions, said X-ray-opacifier comprising said X-ray-opaque glass according to claim 1.

15. A cover glass or substrate glass for electronic components, especially sensors, photovoltaics, display technology, OLEDs and biochemical applications, said cover glass or said substrate glass comprising said X-ray-opaque glass according to claim 1.

16. An element for optical applications, said element comprising said X-ray-opaque-glass according to claim 1.

17. A glass fiber comprising a core glass and a sheathing glass around the core glass, wherein at least one of said core glass and said sheathing glass consists of said X-ray-opaque-glass according to claim 1.

18. An optical wave guide consisting of said X-ray-opaque-glass according to claim 1.

19. A containment material for embedding radioactive materials for storage and/or disposal, said containment material comprising said X-ray-opaque-glass according to claim 1.

20. A packaging material for pharmaceutical compositions, said packaging material comprising said X-ray-opaque-glass according to claim 1.
